(19) United States
(12) Patent Application Publication
(10) Pub. No.: US 2024/0062192 A1
(43) Pub. Date: Feb. 22, 2024

(54) SINGLE STEP STAKING FOR SMART CONTRACTS AND OTHER BLOCKCHAIN TRANSACTIONS

(71) Applicant: DefinQ, Inc., Draper, UT (US)

(72) Inventors: Eric Parker, Draper, UT (US); David Hurst, Draper, UT (US); Brendan Wanlass, Draper, UT (US); David Bland, Draper, UT (US); Adam Olsen, Draper, UT (US)

(21) Appl. No.: 18/235,151

(22) Filed: Aug. 17, 2023

Related U.S. Application Data
(60) Provisional application No. 63/398,951, filed on Aug. 18, 2022.
(60) Provisional application No. 63/398,955, filed on Aug. 18, 2022.
(60) Provisional application No. 63/398,962, filed on Aug. 18, 2022.
(60) Provisional application No. 63/398,970, filed on Aug. 18, 2022.

(51) Int. Cl. G06Q 20/36

(52) U.S. Cl. CPC G06Q 20/3678

(57) ABSTRACT

A method for using metadata to consolidate two transactions into one to execute a smart contract as a single transaction on a blockchain or other distributed ledger. Compared to the previous two-step smart contract execution process, this one-tap process (such as for staking an amount to a pool) allows specifying a predefined amount to execute instead of an exploitable infinite amount.

### CROSS REFERENCE TO RELATED PATENT APPLICATIONS

This application claims priority to U.S. Provisional Application No. 63/398,951 filed on Aug. 18, 2022 entitled “SINGLE STEP STAKING FOR SMART CONTRACTS AND OTHER BLOCKCHAIN TRANSACTIONS” (Attorney Docket No. 5206-0002P), U.S. Provisional Application No. 63/398,955 filed on Aug. 18, 2022 entitled “ENABLING USERS HOLDING ONLY NON-NATIVE TOKENS TO EXECUTE BLOCKCHAIN TRANSACTIONS” (Attorney Docket No. 5206-0003P), U.S. Provisional Application No. 63/398,962 filed on Aug. 18, 2022 entitled “REDUCING GAS FEES FOR SMART CONTRACTS AND OTHER BLOCKCHAIN TRANSACTIONS” (Attorney Docket No. 5206-0004P) and U.S. Provisional Application No. 63/398,970, filed on Aug. 18, 2022 entitled “ELIMINATING THE RACE CONDITION/INFINITE LOOPHOLE FOR SMART CONTRACTS AND OTHER BLOCKCHAIN TRANSACTIONS (Attorney Docket No. 5206-0005P), the entire contents of each of which are hereby incorporated by reference.

### TECHNICAL FIELD

This patent application relates to blockchain smart contract execution.

### BACKGROUND

Blockchain technology is most easily defined as a distributed ledger, where transactions are added one at a time in digital blocks. Once a journal entry has been added to the ledger and all computers operating the network agree that the transaction is valid, a new block is added and can never be undone. Unlike traditional financial technologies where one entity such as a bank controls all access to the assets, blockchains are generally permissionless, transparent, and public.

Bitcoin was the first widely-adopted blockchain technology which created the first cryptocurrency. Bitcoin users created wallets with a public address to receive tokens and a private key to send tokens. There was not much else users could do with bitcoin other than hold tokens in a wallet and send them to other wallets.

That changed when innovators created the Ethereum blockchain which built on the Bitcoin source code and added additional functionality known as smart contracts. Smart contracts are self-executing contracts with the terms directly written into code running on a blockchain. These automated agreements function without an intermediary, much like a vending machine that automatically provides a product once the correct money is inserted.

The invention of smart contracts has allowed blockchain technology to mirror practically every aspect of our existing traditional financial system. Users can execute trades, borrow and lend, create art, earn royalties, create financial derivates like options, create new currencies, and so on, all directly on the blockchain without the need for a bank, broker, or other intermediary. The technology has also allowed for enhanced security where multiple parties are required to approve a single transaction from a shared wallet, such as a company's blockchain address.

### SUMMARY

Existing approaches to blockchain transactions have several problems.

Multi-step staking and the infinite approval bug. The Ethereum blockchain created the ability for users to enter smart contracts which programmatically execute transactions on the blockchain based on predefined conditions being met. This advancement eventually gave rise to the world of decentralized finance (DeFi), and most tokens peculiar to DeFi protocols use the ERC-20 specification.

The ERC-20 specification defines standard practice for entering a smart contract as a two-step process. First, the user approves a token smart contract for a certain token value, which allows another party to receive those funds. Next, the user either sends funds to the other party to the smart contract (in case of a person-to-person transfer) or calls into another smart contract they wish to interact with (such as a decentralized exchange) which is then authorized to receive tokens up to the preapproved amount.

Token prices are generally volatile and blockchain transactions can take seconds, minutes, or even hours or days to execute. This volatility over time can cause transactions to fail if the price exceeds the preapproved threshold for smart contract execution. As a workaround most protocols will set the approval amount to the largest available (effectively an approval for an infinite amount of money) to prevent failure or further approvals being required.

This infinite-approval workaround exposes the transferor to malicious users and smart contracts who can siphon any amount of funds from the transferor's wallet while the contract is open. If a user gets phi shed, stumbles across one of many spoofed DeFi sites, or otherwise contracts with a bad actor, they may approve a contract thinking they're safely testing the water with a small amount to transfer, but, in reality, the value of their entire wallet is at risk of being stolen.

Race condition vulnerability. There is a known bug on the Ethereum blockchain and specifically under the ERC-20 standard known as SWC-114 (https://swcregistry.io/docs/SWC-114) where a bad actor can use a user's single approval to execute the same transaction twice and thus receive multiple amounts of a user's wallet funds. This is yet another byproduct of node operators being able to see blockchain transactions prior to being added to the blockchain, as noted above, and pay higher transaction fees (known as “gas”) to have their transaction prioritized. The difference being that here instead of manipulating the token price, the transferor is directly stealing funds from the transferee.

High gas fees. Virtually all blockchains charge a toll or “transaction fee” for making use of its distributed ledger. These fees are commonly referred to as “gas” or the cost of doing business on the network. Users are subjected to price volatility imposed by the blockchain provider, network congestion and other uncertainties in the gas fees paid to complete a transaction.

Requirement to always hold native token gas. Blockchains generally have a native token (e.g. Bitcoin uses bitcoin, Ethereum uses ETH, Polygon uses MATIC, etc.) as the currency associated with their particular ledger. This requires users who want to transact on the blockchain to always hold a balance of the currency in their wallet to execute transactions. Otherwise, if, for example, a user on Polygon were to stake all of his or her MATIC into a decentralized exchange, that same user would not be able to unstake that same MATIC until he or she acquired more MATIC. As a result, users end up not being able to fully deploy all their capital for investment because balances of every single currency must be held idle and undeployed for potential future transactions.

### BRIEF DESCRIPTION OF PREFERRED EMBODIMENTS

In a preferred embodiment, the approaches described herein consolidate the generally-accepted two-step staking process into a single transaction to eliminate the race condition vulnerability, eliminate the infinite-approval bug, and enable one-tap staking.

Because there is less time between the initial approval and subsequent transfer of funds, there is less chance for the volatility of a token's price to cause a smart contract to fail. Therefore, a specific price can be set in the contract from the outset rather than an infinite amount that exposes the wallet to potential bad actors.

One-tap staking provides additional convenience and reduced gas fees for the user. Network congestion and price volatility can cause transactions to execute slowly or completely fail, and the user must pay gas fees for both transactions. So, reducing two transactions down to one creates a 50% reduction in likelihood of failure, reduction of time to complete a contract, and reduction in cost of gas.

The approaches described herein also alleviate users from needing to hold balances of each blockchain's native currency in their wallets. Users are able to leverage a related gas network to pay for native currencies without needing to acquire or hold any of that currency. This allows users to fully deploy and invest all the capital of their wallets, and they never have to worry about not being able to execute a transaction due to a lack of native currency gas.

The approaches described herein also solve the race condition problem by checking first to see if an approval already exists on the blockchain for another transaction. If an approval does exist, the process will protect the user by terminating the transaction and thus prevent a bad actor from executing the same transaction twice using a single approval.

### BRIEF DESCRIPTION OF THE DRAWINGS

The detailed description below refers to the accompanying drawings, of which:

FIG. 1 is flow for a consolidated one-step staking process.

FIG. 2 is a further flow for alleviating users from needing to hold balances of a blockchain's native currency.

FIGS. 3A through 3E are screenshots of different states within an example mobile application.

FIG. 4 illustrates a typical environment n which the processes of FIGS. 1 and 2 may be implemented.

### DETAILED DESCRIPTION OF PREFERRED EMBODIMENTS

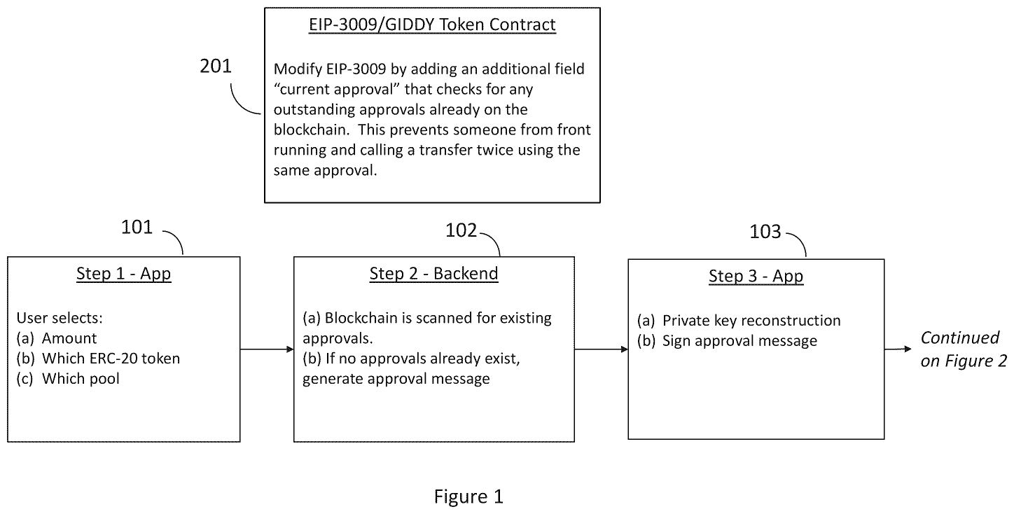

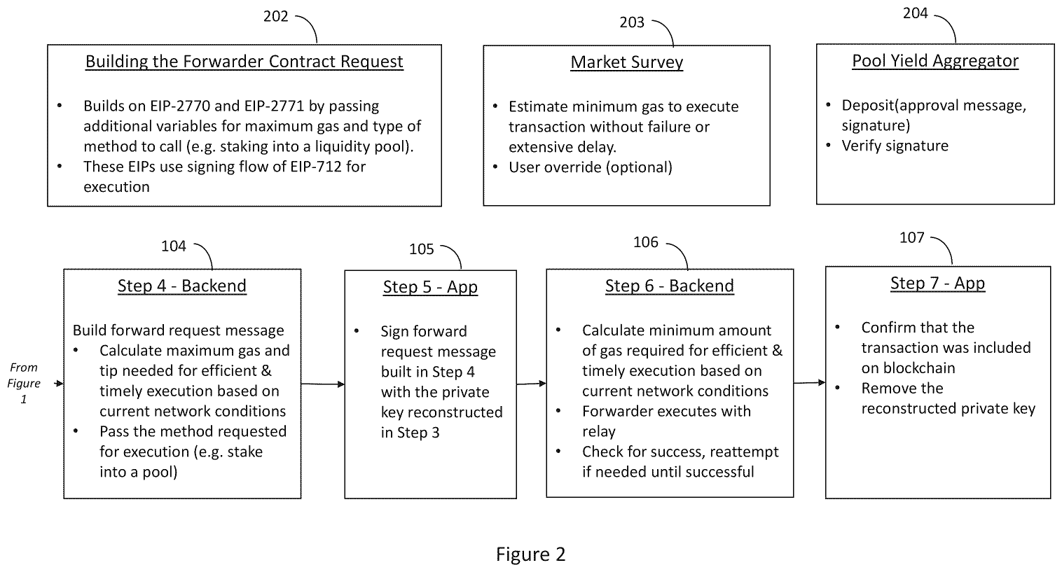

A preferred embodiment of the staking processes described herein may be implemented in a mobile application that interacts with a backend server and a service that accesses a blockchain network. FIGS. 1 and 2 show an example process flow between the user's interaction with the mobile application and corresponding backend action taken to interact with the blockchain. The subsequent paragraphs refer to the steps of the flow in more detail.

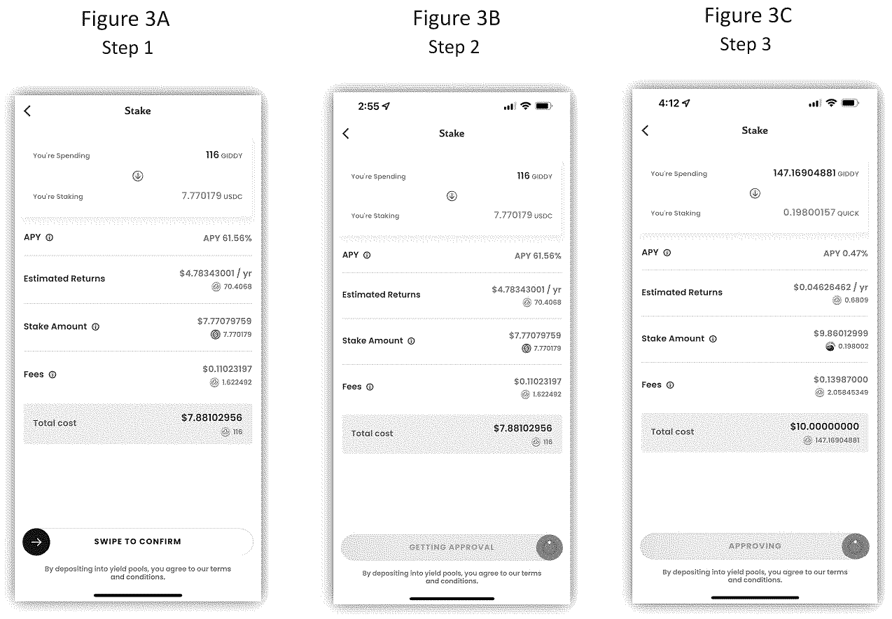

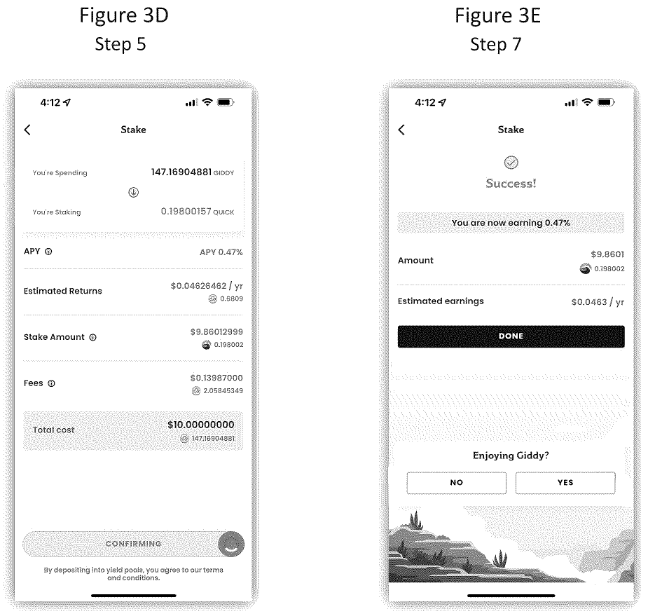

Turning attention to FIG. 1 step 1 (101), the mobile application (which is referred to herein as the “Giddy app”) has a graphical user interface (GUI) that allows the user to view various decentralized finance (DeFi) protocols. The user may select a pool to stake into to earn yield, which ERC-20 token to use to stake into the pool, and the desired amount of the ERC-20 token. As shown in the example screen shot in FIG. 3A, the application may display pertinent information related to the transaction, such as the local fiat value of the amount being staked, estimated annual percentage yield (APY) expected, estimated returns in the native token and in local fiat value, and the gas fees charged by the blockchain network and by the operator of the backend server (referred to herein as the “Giddy backend server”).

It should be understood that although the process described herein is specific to staking a token into a pool to earn interest, the same and/or analogous processes can be adapted to work with many other types of decentralized finance (DeFi) applications and other transactions that involve a blockchain or other distributed ledgers.

Once the user has reviewed the information and is ready to begin the transaction, they swipe the arrow on the bottom of the screen to confirm they want to execute. This begins the next step of interacting with the blockchain itself.

In particular, at step 2 (102) the user's requested transaction information is packaged by the mobile application and sent to Giddy's backend server to generate an approval message that the blockchain can read. This may be performed in an Ethereum network for example, by calling the ERC-3009 function “transferWithAuthorization” which passes parameters that define the transferor, the transferee, the exact amount to be transferred, a nonce (to prevent replay attacks), and other variables that are required for smart contract execution. By passing this information the smart contract can be executed in a single execution rather than the traditional initial approval tap and subsequent execution tap.

In particular, some blockchains support the use of a nonce or other unique data value that cannot be reused on the blockchain, to prevent duplicate transactions.

Additionally, the user's app and backend server may modify the standard ERC-3009 function call to pass one extra parameter called “current approval” (as shown at 202) which causes the backend server to check for any approvals between the same two parties preexisting on the blockchain. If these do exist, an approval of the transaction will not be generated. By running this check before generating the approval, we prevent a bad actor from front running the transaction and calling a transfer more than once using the same approval. A status screen such as shown in FIG. 3B may be displayed by the app at this stage.

Once the approval message has been generated on the backend it must be signed by the user's private key to be executed on the blockchain in step 3 (103). To do this in a secure way, the app may briefly reconstruct the user's private key from various securely stored shards to handle the cryptographic signing of the contract. Example methods for doing so are described in a pending U.S. patent application Ser. No. 18/133,905 filed Apr. 12, 2023 entitled “NON-CUSTODIAL, RECOVERABLE WALLET THAT STORES PRIVATE KEY AMONGST MULTIPLE SECURE STORAGE MECHANISMS” the entire content of which is hereby incorporated by reference herein. This then authorizes the transaction that was composed in Step 2 (102) above to act on the blockchain without any additional action required by the user, since the user has previously authenticated. The user may see a progress screen such as shown in FIG. 3C at this point.

The previous three steps shown in FIG. 1 have had the combined effect of allowing the user to execute transactions on the blockchain with a single approval from the user. The next four steps shown in FIG. 2 enable the user to save on blockchain transactions fees (referred to as “gas”) and pay for this gas without the user needing to hold the gas in the blockchain's specific native token (e.g. all transactions on Ethereum main net require ETH to pay for gas, and all transactions on the Polygon L2 network require MATIC to pay for gas).

Referring to step 4 (104) in FIG. 2, now that the mobile application has reconstructed the user's private key and signed the transaction with all relevant metadata included, a new function may be called to forward this request to a wallet or group of wallets maintained by the backend server we call “Giddy's wallet”. Giddy's wallet holds vast amounts of the native tokens of various blockchains available within the Giddy app (which may be MATIC and ETH, but which may include many more ERC-20 and other L1 chains for example). Giddy's wallet will execute the transaction (as a forward request message) on behalf of the requesting Giddy user.

To accomplish this, step 104 may further involve having Giddy's backend use an execute function supported by the blockchain, which for Ethereum may be ERC-2770 and ERC-2771 which depend on EIP-712. The backend server passes the previously constructed forward request and the user's signature to this execute function, along with two additional parameters: one is an upper limit on gas price willing to be paid to execute the transaction and the other is a generic parameter to decide which method the user wants to call (e.g. stake into the Aave liquidity pool). See item 202 in FIG. 2. At 203 Giddy's server may periodically poll or survey current gas market conditions and provides a reasonable estimate of minimum gas needed to execute the transaction without failure or extensive delay. This estimate may, for example, examine recently completed transactions within a predetermined number of blocks away from a current block. The estimate may be marked up or modified. In some versions, the user may be allowed to override the Giddy backend server's gas estimate (at 204) and allow for higher gas amounts if the user is concerned about priority. This allows Giddy's wallet to execute almost any transaction on behalf of its users without exposing them to exorbitant amounts of gas when network fees spike.

We note here that the signature parameter gives the same signing flow under EIP-712 to allow the user's wallet to directly interact with its ultimate destination. In other words, even though Giddy's wallet acts as the intermediary to execute the transaction smoothly and securely, ultimately it is the user's wallet which ends up directly staked into the ultimate pool or protocol and Giddy's backend wallet is completely disintermediated.

Now that this new forward transaction has been built by the back end, in Step 5 (105) it needs to be signed again by the user's private key. The mobile app once again provides the private key that was reconstructed previously in Step 3 (103) above. This additional signature requires no additional action by the user, once again preserving the one-tap stake functionality. The app may display a process screen to the user at this stage (FIG. 3D).

At Step 6 (106) the backend server now checks the blockchain to gauge exactly how much gas will be needed to execute the transaction in a reasonable amount of time. Gas consists of a base network fee and a “tip” or markup amount to have a user's transaction prioritized by the network. The server then determines the least amount of gas needed for timely execution on the blockchain. The server makes this estimation of gas by reviewing the blocks most recently written to the blockchain, finds the average gas price for blocks that were successfully written within one to two blocks, and provides this value for the user. This is in stark contrast to other approaches which provide users with “low-medium-high” options for spending on gas which often result in either (a) paying extra gas needlessly without a material difference in blockchain execution speed or (b) estimating too low and causing the transaction to sit for long periods of time or sometimes even fail. Our process saves the user significant gas fees by selecting the most efficient number.

Once the transaction is submitted for execution to the blockchain, the backend server waits and watches to verify that the execution took place as expected. If the backend detects a failure, then it will retry the transaction without further interaction needed by the user, once again preserving the one-tap staking feature of the app.

At Step 7 (107), the app may now poll the backend server for completion and deliver either a success screen (FIG. 3E) or failure screen (not shown) to the user depending on the outcome on the blockchain. Once it has received acknowledgement from the server it removes the private key from the device to safeguard the user's account. The process is now complete.

Description of a Preferred Computing Environment.

Ethereum is one possible blockchain technology which may be used to implement the above processes, although other technologies are possible.

Ethereum network—a blockchain technology that enables transfers of value like Bitcoin with the additional functionality of enabling smart contract execution on the chain.

Ethereum Improvement Proposal (EIP) and/or Ethereum Request for Comment (ERC) methods—these are the central methods around which updates and decisions are made on the Ethereum blockchain and are open to all. (The following methods are from the Ethereum Improvement Proposals available at) https://eips.ethereum.org. A copy of each of these EIPs is also submitted herewith and hereby incorporated by reference.

“ERC-3009:Transfer with Authorization”, available at https://eips.ethereum.org/EIPS/eip-3009. A contract interface that enables transferring of fungible assets via a signed authorization.

“ERC-2770: Meta-Transactions Forwarder Contract”, available at https://eips.ethereum.org/EIPS/eip-2770. A standardized contract interface for extensible meta-transaction forwarding. This proposal defines an external API of an extensible Forwarder whose responsibility is to validate transaction signatures on-chain and expose the signer to the destination contract, that is expected to accommodate all use-cases. The EIP-712 structure of the forwarding request can be extended allowing wallets to display readable data even for types not known during the Forwarder contract deployment.

“ERC-2771: Secure Protocol for Native Meta Transactions”, available at https://eips.ethereum.org/EIPS/eip-277. A contract interface for receiving meta transactions through a trusted forwarder. This ERC defines a minimal contract-level protocol that a compliant Recipient contract needs to support to be capable of accepting a meta transaction through a compliant Forwarder contract that it trusts to help it identify the address of the Transaction Signer.

“EIP-712: Typed Structured Data Hashing and Signing”, available at https://eips.ethereum.org/EIPS/eip-712. This is a standard for hashing and signing of typed structured data as opposed to just bytestrings.

It can now be understood how a decentralized finance transaction may proceed. The approach modifies a standard protocol (such as specified by ERC-3009 by adding a “current approval” additional field. This field is used to prompt the backend server to check for any outstanding approvals already on the blockchain. By doing so before the requested transaction is committed to the blockchain, the process can prevent someone else from front running and calling a token transfer twice using the same approval.

The actual cryptographic signing of the smart contract which authorizes the action on the blockchain occurs on the mobile device, and the backend server does not need to retain cryptographic keys.

A forward request (also called “execute”) can pass on a previous request to a backend wallet that stores a quantity of MATIC (or whatever the blockchain's native currency might be). This enables the backend server to execute the transaction on behalf of the requesting user's wallet, eliminating the need for the user to hold the blockchain's native currency.

The actual call to the blockchain can use the standard ERC-2770, ERC-2771 function parameters to forward the transaction. However a MAXIMUM GAS parameter can be leveraged to ensure the appropriate methods to execute the transaction. The backend can thus pretty much call any action on the blockchain AND pay gas on behalf of the user.

The backend server may also confirm how much gas is actually needed based on market conditions to get approved in a reasonable time. The gas calculation may consists of a base fee and a “tip” or markup amount to get priority for the transaction. The backend server may look at network conditions to get the least approval time without needlessly spending gas. (For example a $10 fee might process at the same speed as $0.10 in tips).

A second “signature” parameter can be added as the same signing flow (EIP-712) to get the transaction actually staked into the pool/protocol and disintermediate the backend server.

The rest of the transaction flow can thus be a normal MetaMask-style flow of waiting to actually execute and be written to the blockchain and verify that it really did go through as planned.

A final poll for completion may also trigger removal of any reconstructed private key at the backend. This can scan the blockchain to make sure the transaction really did go through, then wipe the private key, and update the GUI to inform the user of success.

The backend server may also ensure execution, by having the ability to retry a transaction until it is successful. This can happen “behind the scenes” without requiring further input from the user.

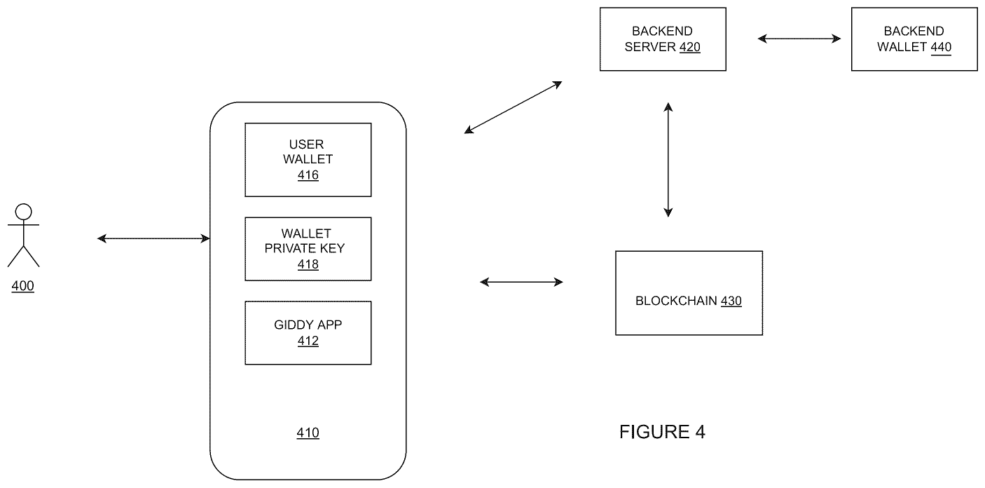

An example system that implements the above-described processes is shown in FIG. 4. These systems and processes may be implemented within a mobile device application 410 that interacts with several different services such as a backend server 420 and a blockchain 430 (or other distributed ledger) to execute decentralized financial (DeFi) transaction on the blockchain 430.

As shown, a user 400 operates a mobile device 410 to run a mobile digital application that we call the Giddy™ application 420. (Giddy is a trademark of DefiQ Corporation of Draper, Utah). The Giddy app 420 enables use of a self-custodial (e.g., non-custodial) user wallet 416 to engage in the decentralized financial (DeFi) transaction such as a cryptocurrency exchange, blockchain, smart contract, or similar transaction. Such a transaction requires the generation of one or more public and private keys 418. The public/private key pair generated can then be used for natively supported blockchain transactions, including things such as peer to peer payments, signing smart contracts, secure digital messaging, and other functions that leverage cryptographic keys stored in the user's wallet 416. More information about the preferred method for storing keys is in the pending U.S. patent application referenced above.

The Giddy app 412 prompts the user to interact with the backend server 420 to complete a transaction using their digital wallet. In particular, the Giddy app 412 interacts with a backend server 420 hosted by trusted cloud service (also referred to herein as the Giddy wallet host 420).

The Giddy app 412 and backend server 420 manage approvals of transactions and interacts with the blockchain 430 and a backend wallet 440 in the particular manners already described above.

The foregoing description of example embodiments provides illustrations and description of example systems and methods for using a blockchain or other distributed ledger for executing smart contracts and other decentralized finance applications, but is not intended to be exhaustive or to limited to the precise form disclosed.

It should be understood, however, that the embodiments described above may be implemented in many different ways. In some instances, the various data processing systems and devices described herein may each be implemented by a separate or shared physical or virtual general purpose computer having a central processor, memory, disk or other mass storage, communication interface(s), input/output (I/O) device(s), and other peripherals. The general purpose computer is transformed into the processors with improved functionality, and executes stored programs to perform the processes described above, to provide improved operations. The processors may operate, for example, by loading software instructions, and then executing the instructions to carry out the functions described. Network interface(s) allow the computer(s) to connect to various other computers and devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof. In some implementations, the computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments may sometimes be preferred as they allow multiple users to access computing resources. By aggregating demand from multiple users in central locations, cloud computing environments can be built in data centers that use the best and newest technology, located in the sustainable and/or centralized locations and designed to achieve the greatest per-unit efficiency possible.

Furthermore, firmware, software, routines, or instructions may be described herein as performing certain actions and/or functions may be implemented on physical devices such as servers, personal computers, mobile devices and the like. Therefore, it should be appreciated that such descriptions contained herein are merely for convenience and that such actions in fact result from various types of computing devices, processors, controllers, or other devices executing the firmware, software, routines, instructions, etc.

It also should be understood that the block, flow and network diagrams may include more or fewer elements, be arranged differently, or be represented differently. It further should be understood that certain implementations may dictate the block, flow and network diagrams and the number of block, flow and network diagrams illustrating the execution of the embodiments be implemented in a particular way.

Other modifications and variations are possible. For example, while a series of steps has been described above with respect to the flow diagrams, the order of the steps may be modified in other implementations. In addition, the steps, operations, and elements may be performed by additional or other modules or entities, which may be combined or separated to form other modules or entities. For example, while a series of steps has been described with regard to certain figures, the order of the steps may be modified in other implementations consistent with the same or analogous principles. Further, non-dependent steps may be performed in parallel.

1. A method for executing a transaction on a blockchain comprising:
at a backend server,
receiving, from a user device operated by a user, a requested transaction including at least a transferor, transferee, amount to be transferred, and other metadata;
confirming that no existing approval for the requested transaction already exists on the blockchain;
requesting, from the user device but without further interaction by the user, a cryptographically signed version of the requested transaction;
generating a current approval for the requested transaction;
submitting the cryptographically signed version of the requested transaction as a single transaction including an approval for the requested transaction for execution on the blockchain without further interaction by or approval from the user or the user device;
receiving a completion status for the requested transaction from the blockchain; and
reporting the completion status of the requested transaction to the user.

2. The method as in claim 1 further using metadata to reduce gas fees charged by the blockchain.

3. The method as in claim 1 wherein the approval for the requested transaction further limits access to a wallet associated with the user to precisely an amount specified in the requested transaction.

4. The method as in claim 1 additionally comprising:
preventing duplicate transaction execution if an approval of the requested transaction already exists.

5. The method as in claim 1 further comprising:
paying gas fees for the requested transaction without needing to hold a blockchain's native currency.

6. The method of claim 1 additionally comprising:
at the backend server, determining if execution of the cryptographically signed version of the transaction was completed, and
if not, then automatically retrying the transaction without further interaction by the user device.

7. The method of claim 1 wherein the requested transaction is a decentralized finance application that stakes the amount to an earnings pool.
